(19) United States
(12) Patent Application Publication
(10) Pub. No.: US 2026/0368257 A1
(43) Pub. Date: Nov. 19, 2026

(54) System and Method for Searching Compacted Binary Coded Decimal Datasets

(71) Applicant: Genesis Research and Technology Group, LLC, Dallas, TX (US)

(72) Inventor: Thomas A. Adcox, Dallas, TX (US)

(21) Appl. No.: 19/674,463

(22) Filed: May 12, 2026

Related U.S. Application Data
(60) Provisional application No. 63/804,920, filed on May 13, 2025.

(51) Int. Cl. G06F 16/903; G06F 16/9032

(52) U.S. Cl. CPC G06F 16/90335; G06F 16/90332

(57) ABSTRACT

A system and method for searching compacted binary coded decimal (BCD) datasets includes an input/output interface, a translation matrix, the compacted BCD dataset, a BCD search index and one or more processors. The BCD search index includes a set of compacted BCD search terms and a location pointer to the compacted BCD dataset for each occurrence of the compacted BCD search terms. The one or more processors are configured to receive a search query from the input/output interface wherein the search query comprises one or more search terms, compact each search query into a compacted BCD search query using the translation matrix, perform a search of the BCD search index for each compacted BCD search term to identify any location pointers corresponding to the compacted BCD search term, and provide a search result to the input/output interface.

### CROSS-REFERENCE TO RELATED APPLICATIONS

This application claims priority to U.S. Provisional Patent Application serial number 63/804,920 filed on May 13, 2025 and entitled System and Method for Searching Compacted Binary Coded Decimal Datasets, the contents of which are incorporated by reference in their entirety.

### TECHNICAL FIELD OF THE DISCLOSURE

The present invention relates in general to the field of data processing, and more particularly, to a system and method for searching compacted binary coded decimal datasets.

### STATEMENT OF FEDERALLY FUNDED RESEARCH

None.

### BACKGROUND OF THE DISCLOSURE

Without limiting the scope of the invention, its background is described in connection with searching compacted binary coded decimal datasets.

U.S. Patent No. 5,351,046 (“the ‘046 Patent”), which is hereby incorporated by reference in its entirety, discloses a method and system for generating a compacted binary coded decimal (BCD) dataset from a BCD digital data stream using a translation matrix to translate blocks of data extracted from the BCD digital data stream. The BCD blocks are read to determine the number and position of 1’s or 0’s in the BCD block. A unique identifier number is then generated from a set of identifiers associated with either each of the 1’s or each of the 0’s. The result is a BCD number that has fewer BCD digits than the original BCD block. This process may be repeated numerous times to result in a compacted BCD dataset that has fewer BCD digits but that can be translated back to the original BCD blocks that form the original BCD data stream. The stated purpose of the ‘046 Patent is to reduce transmission time and storage requirements for BCD data without adversely affecting the BCD data quality. The ‘046 Patent does not disclose how to search the compacted BCD dataset.

Now referring to FIGS. 1A and 1B, exemplary flow diagrams for the compaction and explosion methods of the ‘046 Patent (see FIGS. 7a and 7b) in accordance with the prior art. The automated process for compacting BCD digital data stream into BCD datasets is shown. FIG. 1A shows a flow diagram 80 of the compaction process. In flow chart 80, the first step at block 82 is to open the data file in order to read the digital data stream. Block 84 illustrates, for example, reading digital data stream 10 in 32-bit blocks. Part of the process is to determine whether there are more 1’s than 0’s and whether the greater percentage of 1’s appear in the higher numbered identifier columns. In the event there are more 1’s than 0’s in the 32-bit data block, the method, instead of counting the number of 1’s in the 32-bit data block, is to count the number of 0’s in the 32-bit data block. Likewise, if the greater percentage of 1’s is in the higher numbered columns of the 32-bit data block such that the resulting sum exceeds the maximum value that the 24-bit additive identifier field 24 can contain, the method is to select to count the number of 0’s instead of the number of 1’s. This step is indicated by block 86 of flow chart 80. Once the decision of whether to count 0’s or 1’s is made, the next step is to count to determine the bit level, i.e., the number of 1’s within the 32-bit block as block 88 represents. At the step that block 90 indicates, selection of the proper translation matrix 50 level row 52 occurs. Block 92 represents the step of selecting the proper value for each of the identifiers from the identifier columns of the applicable level row and then adding each of these identifiers to generate the appropriate entry or additive identifier for the resulting BCD number. The resulting BCD number will have 28-bits for characterizing the original 32-bit block. This 28-bitnumber is then written to a temporary file as indicated by block 94.

Query 96 is a test of whether the end of the BCD digital data stream is present. If not, then flow proceeds along path 98 to return to block 84 at which point another 32-bit block is read. On the other hand, if the end of the BCD data field is present, program flow follows path 100 to query 102. At query 102, a test is made of whether the resulting compacted BCD dataset is of the correct or desired size. If the compacted BCD dataset is not of the correct size, then flow control proceeds along path 104 at which point the fold level indicator is incremented by a pre-determined amount, such as an increment of 1. The compacted BCD dataset that the previous level generated is then used as an input for forming 32-bit blocks that will become 24-byte resulting BCD numbers at the next higher fold level. This process may continue until the correct size is positively tested as determined at query 102. Once the compacted BCD dataset is of the desired size, flow control follows path 106 to block 108 at which point the compacted BCD dataset is named and may be stored. The compaction process of the preferred embodiment may then terminate as block 110 represents.

FIG. 1B represents the reverse process of exploding or expanding the compacted BCD dataset by reversing the process of applying intermediate matrix 60. Flow chart 120 of FIG. 5 of the ‘046 Patent begins at block 122 where a file containing a compacted BCD dataset such as compacted BCD dataset 30 of FIG. 2 of the ‘046 Patent. Upon reading the compacted BCD dataset, the first piece of information to extract is the fold level from fold level field 20. Fold level field 20 is followed by numerous 28-bit blocks, as described above, that include the 4-bit level row number and the associated additive identifier as block 126 indicates. After reading the 28-bit BCD number a 32-bit data block can be produced as the next step as block 128 represents. This 32-bit block is then stored temporarily as block 130 indicates.

Query 132 examines whether the end of the compacted BCD dataset is reached. If not, program flow continues along path 134 to return to block 126 where the next 28-bit block is read. If the end of the compacted BCD dataset is reached, then flow proceeds along path 136 to query 138. At query 138, the question of whether the method is at level zero occurs. If the resulting data is not at level zero, i.e., the same as the original BCD digital data stream (e.g., BCD digital data stream 10 of FIG. 1 of the ‘046 Patent), then program flow proceeds along path 140 to use the previously expanded BCD data as the input file and proceeds to block 126. If level zero has been reached, then program flow proceeds along path 142 to block 144 at which point the resulting data will be the original BCD data stream that was previously compacted. This concludes the method of flow chart 120 at block 146.

There is a need for a system and method for searching compacted binary coded decimal datasets.

### SUMMARY OF THE DISCLOSURE

In one embodiment of the present disclosure, a method for searching a compacted binary coded decimal (BCD) dataset includes: providing the compacted BCD dataset, a translation matrix and a BCD search index, wherein any portion of the compacted BCD dataset is translatable to a portion of an original dataset using the translation matrix without any losses, and the BCD search index includes a set of compacted BCD search terms and a location pointer to the compacted BCD dataset for each occurrence of the compacted BCD search terms, receiving, by one or more processors, a search query from an input/output interface, wherein the search query includes one or more search terms, compacting, by the one or more processors, each search term into a compacted BCD search term using the translation matrix, performing, by the one or more processors, a search of the BCD search index for each compacted BCD search term to identify any location pointers corresponding to the compacted BCD search term, and providing, by the one or more processors, a search result to the input/output interface.

In one aspect, the receiving, compacting, performing and providing steps are executed in real time. In another aspect, the search result includes a response indicating whether any location pointers were identified for each BCD search term. In another aspect, the response includes an affirmative response, a negative response or an uncertain response. In another aspect, providing the search result to the input/output interface includes: obtaining, by the one or more processors, one or more compacted BCD data elements from the compacted BCD dataset corresponding to the identified location pointers; and providing, by the one or more processors, the one or more compacted BCD data elements and one more keys to uncompact the BCD data elements to the input/output interface. In another aspect, providing the search result to the input/output interface includes: obtaining, by the one or more processors, one or more compacted BCD data elements from the compacted BCD dataset corresponding to the identified location pointers; uncompacting, by the one or more processors, the one or more compacted BCD data elements into one or more BCD data elements using the translation matrix; and either (1) providing, by the one or more processors, the one or more BCD data elements to the input/output interface, or (2) converting, by the one or more processors, the one or more BCD data elements into one or more data elements, and providing, by the one or more processors, the one or more data elements to the input/output interface. In another aspect, the method further includes determining, by the one or more processors, a relevance of the one or more compacted BCD data elements, the one or more BCD data elements or the one or more data elements. In another aspect, the one or more data elements includes a text string, an e-mail, a web page, a document, an audio/visual recording, a video recording, an audio recording. In another aspect, the search query is received from an artificial intelligence agent or a device communicably coupled to the input/output interface, the search result is sent to the artificial intelligence agent or the device, and the artificial intelligence agent or the device is locally or remotely located with respect to the one or more processors. In another aspect, the method further includes translating, by the one or more processors, the artificial intelligence agent or the device, the search query or the search result into a different language. In another aspect, the method further includes: either (1) providing, by the artificial intelligence agent or the device, the search result to a user, (2) refining, limiting or redefining, by the artificial intelligence agent or the device, the search query and sending a revised search query to the input/output interface, or (3) sending, by the artificial intelligence agent or the device, a request for one or more compacted BCD data elements or the one or more data elements from the compacted BCD dataset corresponding to the identified location pointers to the input/output interface; whenever the revised search query is received by the input/output interface, repeating the compacting, performing, and providing steps, by the one or more processors, for the revised search query; whenever the request for the one or more compacted BCD data elements is received by the input/output interface, (1) obtaining, by the one or more processors, the one or more compacted BCD data elements from the compacted BCD dataset corresponding to the identified location pointers, and (2) providing, by the one or more processors, the one or more compacted BCD data elements and one more keys to uncompact the BCD data elements to the input/output interface; and whenever the request for the one or more data elements is received by the input/output interface, (1) obtaining, by the one or more processors, the one or more compacted BCD data elements from the compacted BCD dataset corresponding to the identified location pointers, (2) uncompacting, by the one or more processors, the one or more compacted BCD data elements into the one or more BCD data elements using the translation matrix, and (3)(a) providing, by the one or more processors, the one or more BCD data elements to the input/output interface, or (b) converting, by the one or more processors, the one or more BCD data elements into the one or more data elements, and providing, by the one or more processors, the one or more data elements to the input/output interface.

In another aspect, the one or more processors include an artificial intelligence search engine. In another aspect, the artificial intelligence search engine learns from the search query and the search result. In another aspect, the method further includes refining, limiting or redefining, by the artificial intelligence search engine, the search query, and repeating the compacting and performing steps, by the artificial intelligence search engine, for the refined, limited or redefined search query. In another aspect, the method further includes: repeating the refining, limiting or redefining the search query step and the compacting and performing steps until one or more new search results are negative; and including, by the artificial intelligence search engine, an output decision based on any of the one or more new search results that are positive in the search result. In another aspect, the method further includes: whenever the search result is positive, (1) determining, by the artificial intelligence search engine, a relevance of the search result to any previous search results, and (2) including, by the artificial intelligence search engine, an output decision based on the relevance of the search result to any previous search results in the search result; and whenever the search result is negative, (1) refining, limiting or redefining, by the artificial intelligence search engine, the search query, and (2) repeating the compacting and performing steps, by the artificial intelligence search engine, for the refined, limited or redefined search query.

In another aspect, the search query includes one or more Boolean operators, or the search term includes a string of alphanumeric characters or symbols, a word, a phrase, an image or a sound. In another aspect, the method further includes interpreting, by the one or more processors, the search query using a natural language model. In another aspect, the location pointer identifies a location of a compacted BCD data element within the compacted BCD dataset or a location of the compacted BCD search term within a compacted BCD data element. In another aspect, the BCD search index further includes one or more adjacent compacted BCD search terms located around the compacted BCD search term within a compacted BCD data element. In another aspect, the method further includes: determining, by the one or more processors, whether the compacted BCD dataset is missing information based on the search result; and providing, by the one or more processors, a message regarding the missing information to the input/output interface. In another aspect, the method further includes: determining, by the one or more processors, whether the compacted BCD dataset is missing information based on the search result; searching, by the one or more processors, one or more data sources for the missing information; obtaining, by the one or more processors, the missing information from the one or more data sources; and adding, by the one or more processors, the missing information to the compacted BCD dataset. In another aspect, adding the missing information to the compacted BCD dataset includes: converting, by the one or more processors, the missing information into BCD information; compacting, by the one or more processors, the BCD information into a compacted BCD information using the translation matrix; adding, by the one or more processors, the compacted BCD information to the compacted BCD dataset; locating, by the one or more processors, a set of compacted BCD search terms withing the compacted BCD information; and adding, by the one or more processors, the set compacted BCD search terms and their corresponding location pointers to the BCD search index. In another aspect, the compacted BCD dataset includes two or more compacted BCD datasets. In another aspect, a set of data elements used to create or update the compacted BCD dataset is not saved or stored. In another aspect, the compacted BCD dataset is searchable in any language. In another aspect, the compacted BCD dataset has been compacted (“folded”) two or more times, the search query is compacted the same number of times as the compacted BCD dataset, and the search result is uncompacted the same number of times as the compacted BCD dataset. In another aspect, the method further includes creating the compacted BCD dataset by: receiving, by the one or more processors, a dataset or a data stream; converting, by the one or more processors, the dataset or the data stream into a BCD dataset; and compacting, by the one or more processors, the BCD dataset into the compacted BCD dataset using the translation matrix. In another aspect, further comprising updating, by the one or more processors, the compacted BCD dataset with new BCD compacted data. In another aspect, the method further includes creating the new compacted BCD data by: receiving, by the one or more processors, a new dataset or new data stream; converting, by the one or more processors, the new dataset or the new data stream into a new BCD dataset; compacting, by the one or more processors, the new BCD dataset into the new compacted BCD data using the translation matrix; adding, by the one or more processors, the new compacted BCD data to the compacted BCD dataset; locating, by the one or more processors, a set of compacted BCD search terms withing the compacted BCD data; and adding, by the one or more processors, the set compacted BCD search terms and their corresponding location pointers to the BCD search index.

Another embodiment of the present disclosure provides a non-transitory computer readable medium having stored thereon a set of instructions for causing one or more processors to search a compacted binary coded decimal (BCD) dataset by performing the steps of: the one or more processors are communicably coupled to the compacted BCD dataset, a translation matrix and a BCD search index, wherein any portion of the compacted BCD dataset is translatable to a portion of an original dataset using the translation matrix without any losses, and the BCD search index includes a set of compacted BCD search terms and a location pointer to the compacted BCD dataset for each occurrence of the compacted BCD search terms; receiving a search query from an input/output interface, wherein the search query includes one or more search terms; compacting each search term into a compacted BCD search term using the translation matrix; performing a search of the BCD search index for each compacted BCD search term to identify any location pointers corresponding to the compacted BCD search term; and providing a search result to the input/output interface.

In one aspect, the receiving, compacting, performing and providing steps are executed in real time. In another aspect, the search result includes a response indicating whether any location pointers were identified for each BCD search term. In one aspect, the response includes an affirmative response, a negative response or an uncertain response. In one aspect, providing the search result to the input/output interface includes: obtaining one or more compacted BCD data elements from the compacted BCD dataset corresponding to the identified location pointers; and providing the one or more compacted BCD data elements and one more keys to uncompact the BCD data elements to the input/output interface. In one aspect, providing the search result to the input/output interface includes: obtaining one or more compacted BCD data elements from the compacted BCD dataset corresponding to the identified location pointers; uncompacting the one or more compacted BCD data elements into one or more BCD data elements using the translation matrix; and either (1) providing the one or more BCD data elements to the input/output interface, or (2) converting the one or more BCD data elements into one or more data elements, and providing the one or more data elements to the input/output interface. In one aspect, the steps further include determining a relevance of the one or more compacted BCD data elements, the one or more BCD data elements or the one or more data elements. In one aspect, the one or more data elements include a text string, an e-mail, a web page, a document, an audio/visual recording, a video recording, an audio recording. In one aspect, the search query is received from an artificial intelligence agent or a device communicably coupled to the input/output interface; the search result is sent to the artificial intelligence agent or the device; and the artificial intelligence agent or the device is locally or remotely located with respect to the one or more processors. In one aspect, the steps further include: whenever a revised search query is received by the input/output interface, repeating the compacting, performing, and providing steps for the revised search query; whenever a request for one or more compacted BCD data elements is received by the input/output interface, (1) obtaining the one or more compacted BCD data elements from the compacted BCD dataset corresponding to the identified location pointers, and (2) providing the one or more compacted BCD data elements and one more keys to uncompact the BCD data elements to the input/output interface; and whenever a request for the one or more data elements is received by the input/output interface, (1) obtaining the one or more compacted BCD data elements from the compacted BCD dataset corresponding to the identified location pointers, (2) uncompacting the one or more compacted BCD data elements into the one or more BCD data elements using the translation matrix, and (3)(a) providing the one or more BCD data elements to the input/output interface, or (b) converting the one or more BCD data elements into the one or more data elements, and providing the one or more data elements to the input/output interface.

In one aspect, the one or more processors include an artificial intelligence search engine. In one aspect, the artificial intelligence search engine learns from the search query and the search result. In one aspect, the steps further include refining, limiting or redefining the search query, and repeating the compacting and performing steps for the refined, limited or redefined search query. In one aspect, the steps further include: repeating the refining, limiting or redefining the search query step and the compacting and performing steps until one or more new search results are negative; and including an output decision based on any of the one or more new search results that are positive in the search result. In one aspect, the steps further include: whenever the search result is positive, (1) determining a relevance of the search result to any previous search results, and (2) including an output decision based on the relevance of the search result to any previous search results in the search result; and whenever the search result is negative, (1) refining, limiting or redefining the search query, and (2) repeating the compacting and performing steps for the refined, limited or redefined search query.

In one aspect, the search query includes one or more Boolean operators, or the search term includes a string of alphanumeric characters or symbols, a word, a phrase, an image or a sound. In one aspect, the steps further include interpreting the search query using a natural language model. In one aspect, the location pointer identifies a location of a compacted BCD data element within the compacted BCD dataset or a location of the compacted BCD search term within a compacted BCD data element. In one aspect, the BCD search index further includes one or more adjacent compacted BCD search terms located around the compacted BCD search term within a compacted BCD data element. In one aspect, the steps further include: determining whether the compacted BCD dataset is missing information based on the search result; and providing a message regarding the missing information to the input/output interface. In another aspect, the steps further include: determining whether the compacted BCD dataset is missing information based on the search result; searching one or more data sources for the missing information; obtaining the missing information from the one or more data sources; and adding the missing information to the compacted BCD dataset. In one aspect, adding the missing information to the compacted BCD dataset includes: converting the missing information into BCD information; compacting the BCD information into a compacted BCD information using the translation matrix; adding the compacted BCD information to the compacted BCD dataset; locating a set of compacted BCD search terms withing the compacted BCD information; and adding the set compacted BCD search terms and their corresponding location pointers to the BCD search index. In one aspect, the compacted BCD dataset includes two or more compacted BCD datasets. In one aspect, a set of data elements used to create or update the compacted BCD dataset is not saved or stored. In one aspect, the compacted BCD dataset is searchable in any language. In one aspect, the compacted BCD dataset has been compacted (“folded”) two or more times, the search query is compacted the same number of times as the compacted BCD dataset, and the search result is uncompacted the same number of times as the compacted BCD dataset. In one aspect, the steps further include creating the compacted BCD dataset by: receiving a dataset or a data stream; converting the dataset or the data stream into a BCD dataset; and compacting the BCD dataset into the compacted BCD dataset using the translation matrix. In one aspect, the steps further include updating the compacted BCD dataset with new BCD compacted data. In one aspect, the steps further include creating the new compacted BCD data by: receiving a new dataset or new data stream; converting the new dataset or the new data stream into a new BCD dataset; compacting the new BCD dataset into the new compacted BCD data using the translation matrix; adding the new compacted BCD data to the compacted BCD dataset; locating a set of compacted BCD search terms withing the compacted BCD data; and adding the set compacted BCD search terms and their corresponding location pointers to the BCD search index.

In another embodiment of the present disclosure, a system for searching a compacted binary coded decimal (BCD) dataset includes: an input/output interface, a translation matrix, the compacted BCD dataset, a BCD search index, and one or more processors communicably coupled to the input/output interface, the translation matrix, the compacted BCD dataset and the BCD search index. Any portion of the compacted BCD dataset is translatable to a portion of an original dataset using the translation matrix without any losses. The BCD search index includes a set of compacted BCD search terms and a location pointer to the compacted BCD dataset for each occurrence of the compacted BCD search terms. The one or more processors are configured to receive a search query from the input/output interface wherein the search query includes one or more search terms, compact each search query into a compacted BCD search query using the translation matrix, perform a search of the BCD search index for each compacted BCD search term to identify any location pointers corresponding to the compacted BCD search term, and provide a search result to the input/output interface. In one aspect, the one or more processors execute the receiving, compacting, performing and providing steps real time. In another aspect, the search result includes a response indicating whether any location pointers were identified for each BCD search term. In another aspect, the response includes an affirmative response, a negative response or an uncertain response. In another aspect, the one or more processors provide the search result to the input/output interface by: obtaining one or more compacted BCD data elements from the compacted BCD dataset corresponding to the identified location pointers; and providing the one or more compacted BCD data elements and one more keys to uncompact the BCD data elements to the input/output interface. In another aspect, the one or more processors provide the search result to the input/output interface by: obtaining one or more compacted BCD data elements from the compacted BCD dataset corresponding to the identified location pointers; uncompacting the one or more compacted BCD data elements into one or more BCD data elements using the translation matrix; and either (1) providing the one or more BCD data elements to the input/output interface, or (2) converting the one or more BCD data elements into one or more data elements, and providing the one or more data elements to the input/output interface. In another aspect, the one or more processors determine a relevance of the one or more compacted BCD data elements, the one or more BCD data elements or the one or more data elements. In another aspect, the one or more data elements include a text string, an e-mail, a web page, a document, an audio/visual recording, a video recording, an audio recording. In another aspect, the search query is received from an artificial intelligence agent or a device communicably coupled to the input/output interface, the search result is sent to the artificial intelligence agent or the device, and the artificial intelligence agent or the device is locally or remotely located with respect to the one or more processors. In another aspect, the one or more processors, the artificial intelligence agent or the device translate the search query or the search result into a different language. In another aspect, the artificial intelligence agent or the device either (1) provides the search result to a user, (2) refines, limits or redefines the search query and sends a revised search query to the input/output interface, or (3) sends a request for one or more compacted BCD data elements or the one or more data elements from the compacted BCD dataset corresponding to the identified location pointers to the input/output interface; whenever the revised search query is received by the input/output interface, the one or more processors repeat the compacting, performing, and providing steps for the revised search query; whenever the request for the one or more compacted BCD data elements is received by the input/output interface, the one or more processors (1) obtain the one or more compacted BCD data elements from the compacted BCD dataset corresponding to the identified location pointers, and (2) provide the one or more compacted BCD data elements and one more keys to uncompact the BCD data elements to the input/output interface; and whenever the request for the one or more data elements is received by the input/output interface, the one or more processors (1) obtain the one or more compacted BCD data elements from the compacted BCD dataset corresponding to the identified location pointers, (2) uncompact the one or more compacted BCD data elements into the one or more BCD data elements using the translation matrix, and (3)(a) provide the one or more BCD data elements to the input/output interface, or (b) convert the one or more BCD data elements into the one or more data elements, and provide the one or more data elements to the input/output interface.

In another aspect, the one or more processors include an artificial intelligence search engine. In another aspect, the artificial intelligence search engine learns from the search query and the search result. In another aspect, the artificial intelligence search engine refines, limits or redefines the search query, and repeats the compacting and performing steps for the refined, limited or redefined search query. In another aspect, the artificial intelligence search engine: repeats the refining, limiting or redefining the search query step and the compacting and performing steps until one or more new search results are negative; and includes an output decision based on any of the one or more new search results that are positive in the search result. In another aspect, the artificial intelligence search engine: whenever the search result is positive, (1) determines a relevance of the search result to any previous search results, and (2) includes an output decision based on the relevance of the search result to any previous search results in the search result; and whenever the search result is negative, (1) refines, limits or redefines the search query, and (2) repeats the compacting and performing steps for the refined, limited or redefined search query.

In another aspect, the search query includes one or more Boolean operators, or the search term includes a string of alphanumeric characters or symbols, a word, a phrase, an image or a sound. In another aspect, the one or more processors interpret the search query using a natural language model. In another aspect, the location pointer identifies a location of a compacted BCD data element within the compacted BCD dataset or a location of the compacted BCD search term within a compacted BCD data element. In another aspect, the BCD search index further includes one or more adjacent compacted BCD search terms located around the compacted BCD search term within a compacted BCD data element. In another aspect, the one or more processors: determine whether the compacted BCD dataset is missing information based on the search result; and provide a message regarding the missing information to the input/output interface. In another aspect, the one or more processors: determine whether the compacted BCD dataset is missing information based on the search result; search one or more data sources for the missing information; obtain the missing information from the one or more data sources; and add the missing information to the compacted BCD dataset. In another aspect, the one or more processors add the missing information to the compacted BCD dataset by: converting the missing information into BCD information; compacting the BCD information into a compacted BCD information using the translation matrix; adding the compacted BCD information to the compacted BCD dataset; locating a set of compacted BCD search terms withing the compacted BCD information; and adding the set compacted BCD search terms and their corresponding location pointers to the BCD search index. In another aspect, the compacted BCD dataset includes two or more compacted BCD datasets. In another aspect, a set of data elements used to create or update the compacted BCD dataset is not saved or stored. In another aspect, the compacted BCD dataset is searchable in any language. In another aspect, the compacted BCD dataset has been compacted (“folded”) two or more times, the search query is compacted the same number of times as the compacted BCD dataset, and the search result is uncompacted the same number of times as the compacted BCD dataset. In another aspect, the one or more processors create the compacted BCD dataset by: receiving a dataset or a data stream; converting the dataset or the data stream into a BCD dataset; and compacting the BCD dataset into the compacted BCD dataset using the translation matrix. In another aspect, the one or more processors update the compacted BCD dataset with new BCD compacted data. In another aspect, the one or more processors create the new compacted BCD data by: receiving a new dataset or new data stream; converting the new dataset or the new data stream into a new BCD dataset; compacting the new BCD dataset into the new compacted BCD data using the translation matrix; adding the new compacted BCD data to the compacted BCD dataset; locating a set of compacted BCD search terms withing the compacted BCD data; and adding the set compacted BCD search terms and their corresponding location pointers to the BCD search index.

Note that the invention is not limited to the embodiments, instead it has the applicability beyond the embodiments herein. The brief and detailed descriptions of this invention are given in the following.

### BRIEF DESCRIPTION OF THE DRAWINGS

For a more complete understanding of the features and advantages of the present invention, reference is now made to the detailed description of the invention along with the accompanying figures and in which:

FIGS. 1A and 1B are exemplary flow diagrams for the compaction and explosion methods of the ‘046 Patent (see FIGS. 7a and 7b) in accordance with the prior art;

FIG. 2 is a block diagram of a system for searching a compacted binary coded decimal (BCD) dataset in accordance with one embodiment of the present disclosure;

FIG. 3 is a flow chart of a method for searching a compacted BCD dataset in accordance with one embodiment of the present disclosure;

FIG. 4 is a flow chart of a search process in accordance with one embodiment of the present disclosure;

FIG. 5 is a flow chart of an exemplary search in accordance with one embodiment of the present disclosure; and

FIG. 6 is a flow chart of an exemplary system in accordance with one embodiment of the present invention.

### DETAILED DESCRIPTION OF THE DISCLOSURE

While the making and using of various embodiments of the present invention are discussed in detail below, it should be appreciated that the present invention provides many applicable inventive concepts that can be embodied in a wide variety of specific contexts. The specific embodiments discussed herein are merely illustrative of specific ways to make and use the invention and do not delimit the scope of the invention.

To facilitate the understanding of this invention, a number of terms are defined below. Terms defined herein have meanings as commonly understood by a person of ordinary skill in the areas relevant to the present invention. Terms such as “a”, “an” and “the” are not intended to refer to only a singular entity but include the general class of which a specific example may be used for illustration. The terminology herein is used to describe specific embodiments of the invention, but their usage does not limit the invention, except as outlined in the claims.

Various methods are described below to provide an example of each claimed embodiment. They do not limit any claimed embodiment. Any claimed embodiment may cover methods that are different from those described above and below. The drawings and descriptions are for illustrative, rather than restrictive, purposes.

Using the capabilities described in the ‘046 Patent, the following capabilities are now achievable, with a loose usage of the Cartisan Retrieval Method and the above compressed data, searching for relative data for usage in all forms of AI is possible without having to unfold or restore the data prior to the search. The data is stored in a relational formatted database which allows the content to any depth before, around, near, or after to be also retrieved without having to go to the original document or any representation other that the stored format. Since this data is conserved in its original format, relativity can be processed on all locations of the sought after information necessary as input to the calling AI engine, in it get or retrieve request without having to use large volumes of storage or memory and the number of operations to retrieve said data while enjoy a large multitude of reduced computational power to provide such. Note that the present disclosure is not limited to the specific embodiments disclosed in the ‘049 Patent. Other BCD compacting/uncompacting methods can be used

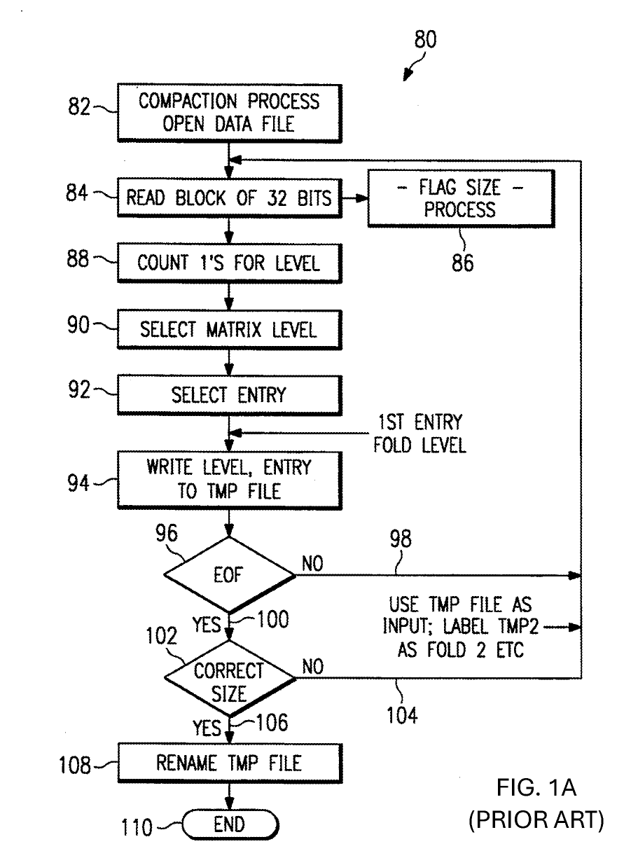

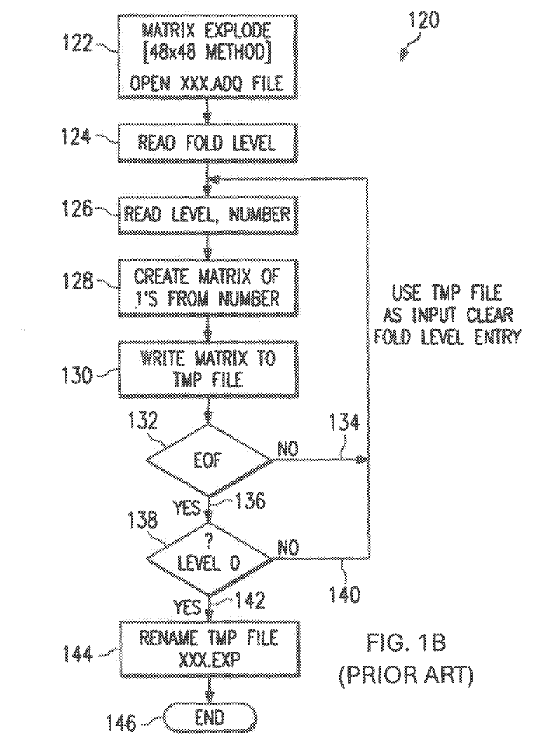

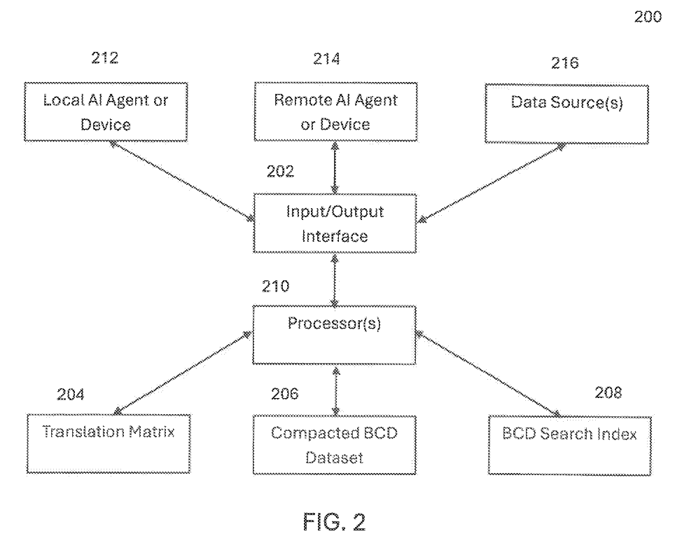

Now referring to FIG. 2, a block diagram of a system 200 for searching a compacted binary coded decimal (BCD) dataset in accordance with one embodiment of the present disclosure is shown. The system 200 includes an input/output interface 202, a translation matrix 204, the compacted BCD dataset 206, a BCD search index 208, and one or more processors 210 communicably coupled to the input/output interface 202, the translation matrix 204, the compacted BCD dataset 206 and the BCD search index 208. The one or more processors 210 can be in a single device or distributed across several local or remote devices. The input/output interface 202 can be communicably coupled to any type of local or remote device, such local artificial agent or device 212, remote artificial agent or device 214 or one or more data sources 216, etc. The compacted BCD dataset 206 is based on the embodiment illustrated in FIGS. 1A and 1B or variants thereof that currently exist or are developed in the future. Moreover, the compacted BCD dataset 206 is not limited to the embodiment illustrated in FIGS. 1A and 1B. Any portion of the compacted BCD dataset 206 is translatable to a portion of an original dataset using the translation matrix 204 without any losses. The BCD search index 208 includes a set of compacted BCD search terms and a location pointer to the compacted BCD dataset 206 for each occurrence of the compacted BCD search terms. The one or more processors 210 are configured to receive a search query from the input/output interface 202 wherein the search query includes one or more search terms, compact each search query into a compacted BCD search query using the translation matrix 204, perform a search of the BCD search index 208 for each compacted BCD search term to identify any location pointers corresponding to the compacted BCD search term, and provide a search result to the input/output interface 202.

In one aspect, the one or more processors 210 execute the receiving, compacting, performing and providing steps real time. In another aspect, the search result includes a response indicating whether any location pointers were identified for each BCD search term. In another aspect, the response includes an affirmative response, a negative response or an uncertain response. In another aspect, the one or more processors 210 provide the search result to the input/output interface 202 by: obtaining one or more compacted BCD data elements from the compacted BCD dataset 206 corresponding to the identified location pointers; and providing the one or more compacted BCD data elements and one more keys to uncompact the BCD data elements to the input/output interface 202. In another aspect, the one or more processors 210 provide the search result to the input/output interface 202 by: obtaining one or more compacted BCD data elements from the compacted BCD dataset 206 corresponding to the identified location pointers; uncompacting the one or more compacted BCD data elements into one or more BCD data elements using the translation matrix 204; and either (1) providing the one or more BCD data elements to the input/output interface 202, or (2) converting the one or more BCD data elements into one or more data elements, and providing the one or more data elements to the input/output interface 202. In another aspect, the one or more processors 210 determine a relevance of the one or more compacted BCD data elements, the one or more BCD data elements or the one or more data elements. In another aspect, the one or more data elements include a text string, an e-mail, a web page, a document, an audio/visual recording, a video recording, an audio recording, or anything that is machine-readable and machine storable. In another aspect, the search query is received from an artificial intelligence agent or a device 212 or 214 communicably coupled to the input/output interface 202, the search result is sent to the artificial intelligence agent or the device 212 or 214. In another aspect, the one or more processors 210, the artificial intelligence agent or the device 212 or 214 translate the search query or the search result into a different language. In another aspect, the artificial intelligence agent or the device 212 or 214 either (1) provides the search result to a user, (2) refines, limits or redefines the search query and sends a revised search query to the input/output interface 202, or (3) sends a request for one or more compacted BCD data elements or the one or more data elements from the compacted BCD dataset corresponding to the identified location pointers to the input/output interface 202; whenever the revised search query is received by the input/output interface 202, the one or more processors 210 repeat the compacting, performing, and providing steps for the revised search query; whenever the request for the one or more compacted BCD data elements is received by the input/output interface 202, the one or more processors 210 (1) obtain the one or more compacted BCD data elements from the compacted BCD dataset 206 corresponding to the identified location pointers, and (2) provide the one or more compacted BCD data elements and one more keys to uncompact the BCD data elements to the input/output interface 202; and whenever the request for the one or more data elements is received by the input/output interface 202, the one or more processors 210 (1) obtain the one or more compacted BCD data elements from the compacted BCD dataset 206 corresponding to the identified location pointers, (2) uncompact the one or more compacted BCD data elements into the one or more BCD data elements using the translation matrix, and (3)(a) provide the one or more BCD data elements to the input/output interface 202, or (b) convert the one or more BCD data elements into the one or more data elements, and provide the one or more data elements to the input/output interface 202. The artificial intelligence agent can be any machine learning software or hardware, existing now or in the future.

In another aspect, the one or more processors 202 include an artificial intelligence search engine. The artificial intelligence search engine can be any machine learning software or hardware, existing now or in the future. In another aspect, the artificial intelligence search engine learns from the search query and the search result. In another aspect, the artificial intelligence search engine refines, limits or redefines the search query, and repeats the compacting and performing steps for the refined, limited or redefined search query. In another aspect, the artificial intelligence search engine: repeats the refining, limiting or redefining the search query step and the compacting and performing steps until one or more new search results are negative; and includes an output decision based on any of the one or more new search results that are positive in the search result. In another aspect, the artificial intelligence search engine: whenever the search result is positive, (1) determines a relevance of the search result to any previous search results, and (2) includes an output decision based on the relevance of the search result to any previous search results in the search result; and whenever the search result is negative, (1) refines, limits or redefines the search query, and (2) repeats the compacting and performing steps for the refined, limited or redefined search query.

In another aspect, the search query includes one or more Boolean operators, or the search term includes a string of alphanumeric characters or symbols, a word, a phrase, an image or a sound. In another aspect, the one or more processors 210 interpret the search query using a natural language model. In another aspect, the location pointer identifies a location of a compacted BCD data element within the compacted BCD dataset 206 or a location of the compacted BCD search term within a compacted BCD data element. In another aspect, the BCD search index 208 further includes one or more adjacent compacted BCD search terms located around the compacted BCD search term within a compacted BCD data element. In another aspect, the one or more processors 210: determine whether the compacted BCD database 206 is missing information based on the search result; and provide a message regarding the missing information to the input/output interface 202. In another aspect, the one or more processors 210: determine whether the compacted BCD dataset 206 is missing information based on the search result; search one or more data sources 216 for the missing information; obtain the missing information from the one or more data sources 216; and add the missing information to the compacted BCD dataset 206. In another aspect, the one or more processors 210 add the missing information to the compacted BCD dataset 206 by: converting the missing information into BCD information; compacting the BCD information into a compacted BCD information using the translation matrix 204; adding the compacted BCD information to the compacted BCD dataset 206; locating a set of compacted BCD search terms withing the compacted BCD information; and adding the set compacted BCD search terms and their corresponding location pointers to the BCD search index 208. In another aspect, the compacted BCD dataset 206 includes two or more compacted BCD datasets. In another aspect, a set of data elements used to create or update the compacted BCD dataset 206 is not saved or stored. In another aspect, the compacted BCD dataset 206 is searchable in any language. In another aspect, the compacted BCD dataset 206 has been compacted (“folded”) two or more times, the search query is compacted the same number of times as the compacted BCD dataset, and the search result is uncompacted the same number of times as the compacted BCD dataset 206. In another aspect, the one or more processors 210 create the compacted BCD dataset 206 by: receiving a dataset or a data stream; converting the dataset or the data stream into a BCD dataset; and compacting the BCD dataset into the compacted BCD dataset 206 using the translation matrix 204. In another aspect, the one or more processors 210 update the compacted BCD dataset 206 with new BCD compacted data. In another aspect, the one or more processors 210 create the new compacted BCD data by: receiving a new dataset or new data stream; converting the new dataset or the new data stream into a new BCD dataset; compacting the new BCD dataset into the new compacted BCD data using the translation matrix 204; adding the new compacted BCD data to the compacted BCD dataset 206; locating a set of compacted BCD search terms withing the compacted BCD dataset 206; and adding the set compacted BCD search terms and their corresponding location pointers to the BCD search index 208.

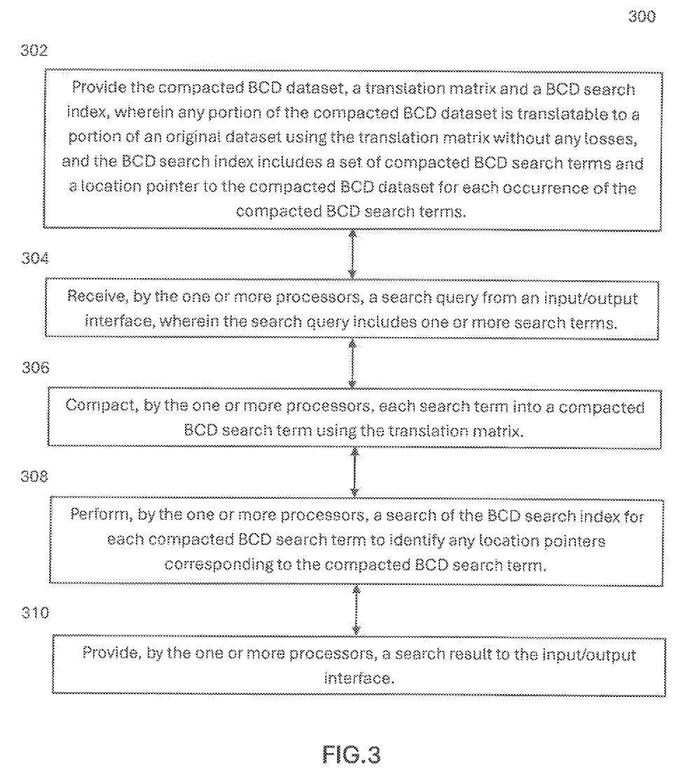

Referring now to FIG. 3, a flow chart of method 300 for searching a compacted binary coded decimal (BCD) dataset in accordance with one embodiment of the present disclosure is shown. The compacted BCD dataset, a translation matrix and a BCD search index are provided in block 302. Any portion of the compacted BCD dataset is translatable to a portion of an original dataset using the translation matrix without any losses. The BCD search index includes a set of compacted BCD search terms and a location pointer to the compacted BCD dataset for each occurrence of the compacted BCD search terms. One or more processors receive a search query from an input/output interface in block 304, wherein the search query includes one or more search terms. The one or more processors compact each search term into a compacted BCD search term using the translation matrix in block 306. The one or more processors perform a search of the BCD search index for each compacted BCD search term to identify any location pointers corresponding to the compacted BCD search term in block 308. The one or more processors provide a search result to the input/output interface in block 310.

In one aspect, the receiving, compacting, performing and providing steps are executed in real time. In another aspect, the search result includes a response indicating whether any location pointers were identified for each BCD search term. In another aspect, the response includes an affirmative response, a negative response or an uncertain response. In another aspect, providing the search result to the input/output interface includes: obtaining, by the one or more processors, one or more compacted BCD data elements from the compacted BCD dataset corresponding to the identified location pointers; and providing, by the one or more processors, the one or more compacted BCD data elements and one more keys to uncompact the BCD data elements to the input/output interface. In another aspect, providing the search result to the input/output interface includes: obtaining, by the one or more processors, one or more compacted BCD data elements from the compacted BCD dataset corresponding to the identified location pointers; uncompacting, by the one or more processors, the one or more compacted BCD data elements into one or more BCD data elements using the translation matrix; and either (1) providing, by the one or more processors, the one or more BCD data elements to the input/output interface, or (2) converting, by the one or more processors, the one or more BCD data elements into one or more data elements, and providing, by the one or more processors, the one or more data elements to the input/output interface. In another aspect, the method further includes determining, by the one or more processors, a relevance of the one or more compacted BCD data elements, the one or more BCD data elements or the one or more data elements. In another aspect, the one or more data elements includes a text string, an e-mail, a web page, a document, an audio/visual recording, a video recording, an audio recording, or anything that anything that is machine-readable and machine storable. In another aspect, the search query is received from an artificial intelligence agent or a device communicably coupled to the input/output interface, the search result is sent to the artificial intelligence agent or the device, and the artificial intelligence agent or the device is locally or remotely located with respect to the one or more processors. In another aspect, the method further includes translating, by the one or more processors, the artificial intelligence agent or the device, the search query or the search result into a different language. In another aspect, the method further includes: either (1) providing, by the artificial intelligence agent or the device, the search result to a user, (2) refining, limiting or redefining, by the artificial intelligence agent or the device, the search query and sending a revised search query to the input/output interface, or (3) sending, by the artificial intelligence agent or the device, a request for one or more compacted BCD data elements or the one or more data elements from the compacted BCD dataset corresponding to the identified location pointers to the input/output interface; whenever the revised search query is received by the input/output interface, repeating the compacting, performing, and providing steps, by the one or more processors, for the revised search query; whenever the request for the one or more compacted BCD data elements is received by the input/output interface, (1) obtaining, by the one or more processors, the one or more compacted BCD data elements from the compacted BCD dataset corresponding to the identified location pointers, and (2) providing, by the one or more processors, the one or more compacted BCD data elements and one more keys to uncompact the BCD data elements to the input/output interface; and whenever the request for the one or more data elements is received by the input/output interface, (1) obtaining, by the one or more processors, the one or more compacted BCD data elements from the compacted BCD dataset corresponding to the identified location pointers, (2) uncompacting, by the one or more processors, the one or more compacted BCD data elements into the one or more BCD data elements using the translation matrix, and (3)(a) providing, by the one or more processors, the one or more BCD data elements to the input/output interface, or (b) converting, by the one or more processors, the one or more BCD data elements into the one or more data elements, and providing, by the one or more processors, the one or more data elements to the input/output interface. The artificial intelligence agent can be any machine learning software or hardware, existing now or in the future.

In another aspect, the one or more processors include an artificial intelligence search engine. The artificial intelligence search engine can be any machine learning software or hardware, existing now or in the future. In another aspect, the artificial intelligence search engine learns from the search query and the search result. In another aspect, the method further includes refining, limiting or redefining, by the artificial intelligence search engine, the search query, and repeating the compacting and performing steps, by the artificial intelligence search engine, for the refined, limited or redefined search query. In another aspect, the method further includes: repeating the refining, limiting or redefining the search query step and the compacting and performing steps until one or more new search results are negative; and including, by the artificial intelligence search engine, an output decision based on any of the one or more new search results that are positive in the search result. In another aspect, the method further includes: whenever the search result is positive, (1) determining, by the artificial intelligence search engine, a relevance of the search result to any previous search results, and (2) including, by the artificial intelligence search engine, an output decision based on the relevance of the search result to any previous search results in the search result; and whenever the search result is negative, (1) refining, limiting or redefining, by the artificial intelligence search engine, the search query, and (2) repeating the compacting and performing steps, by the artificial intelligence search engine, for the refined, limited or redefined search query.

In another aspect, the search query includes one or more Boolean operators, or the search term includes a string of alphanumeric characters or symbols, a word, a phrase, an image or a sound. In another aspect, the method further includes interpreting, by the one or more processors, the search query using a natural language model. In another aspect, the location pointer identifies a location of a compacted BCD data element within the compacted BCD dataset or a location of the compacted BCD search term within a compacted BCD data element. In another aspect, the BCD search index further includes one or more adjacent compacted BCD search terms located around the compacted BCD search term within a compacted BCD data element. In another aspect, the method further includes: determining, by the one or more processors, whether the compacted BCD dataset is missing information based on the search result; and providing, by the one or more processors, a message regarding the missing information to the input/output interface. In another aspect, the method further includes: determining, by the one or more processors, whether the compacted BCD dataset is missing information based on the search result; searching, by the one or more processors, one or more data sources for the missing information; obtaining, by the one or more processors, the missing information from the one or more data sources; and adding, by the one or more processors, the missing information to the compacted BCD dataset. In another aspect, adding the missing information to the compacted BCD dataset includes: converting, by the one or more processors, the missing information into BCD information; compacting, by the one or more processors, the BCD information into a compacted BCD information using the translation matrix; adding, by the one or more processors, the compacted BCD information to the compacted BCD dataset; locating, by the one or more processors, a set of compacted BCD search terms withing the compacted BCD information; and adding, by the one or more processors, the set compacted BCD search terms and their corresponding location pointers to the BCD search index. In another aspect, the compacted BCD dataset includes two or more compacted BCD datasets. In another aspect, a set of data elements used to create or update the compacted BCD dataset is not saved or stored. In another aspect, the compacted BCD dataset is searchable in any language. In another aspect, the compacted BCD dataset has been compacted (“folded”) two or more times, the search query is compacted the same number of times as the compacted BCD dataset, and the search result is uncompacted the same number of times as the compacted BCD dataset. In another aspect, the method further includes creating the compacted BCD dataset by: receiving, by the one or more processors, a dataset or a data stream; converting, by the one or more processors, the dataset or the data stream into a BCD dataset; and compacting, by the one or more processors, the BCD dataset into the compacted BCD dataset using the translation matrix. In another aspect, further comprising updating, by the one or more processors, the compacted BCD dataset with new BCD compacted data. In another aspect, the method further includes creating the new compacted BCD data by: receiving, by the one or more processors, a new dataset or new data stream; converting, by the one or more processors, the new dataset or the new data stream into a new BCD dataset; compacting, by the one or more processors, the new BCD dataset into the new compacted BCD data using the translation matrix; adding, by the one or more processors, the new compacted BCD data to the compacted BCD dataset; locating, by the one or more processors, a set of compacted BCD search terms withing the compacted BCD data; and adding, by the one or more processors, the set compacted BCD search terms and their corresponding location pointers to the BCD search index.

Another embodiment of the present disclosure provides a non-transitory computer readable medium having stored thereon a set of instructions for causing one or more processors to search a compacted binary coded decimal (BCD) dataset by performing the steps of: the one or more processors are communicably coupled to the compacted BCD dataset, a translation matrix and a BCD search index, wherein any portion of the compacted BCD dataset is translatable to a portion of an original dataset using the translation matrix without any losses, and the BCD search index includes a set of compacted BCD search terms and a location pointer to the compacted BCD dataset for each occurrence of the compacted BCD search terms; receiving a search query from an input/output interface, wherein the search query includes one or more search terms; compacting each search term into a compacted BCD search term using the translation matrix; performing a search of the BCD search index for each compacted BCD search term to identify any location pointers corresponding to the compacted BCD search term; and providing a search result to the input/output interface.

In one aspect, the receiving, compacting, performing and providing steps are executed in real time. In another aspect, the search result includes a response indicating whether any location pointers were identified for each BCD search term. In one aspect, the response includes an affirmative response, a negative response or an uncertain response. In one aspect, providing the search result to the input/output interface includes: obtaining one or more compacted BCD data elements from the compacted BCD dataset corresponding to the identified location pointers; and providing the one or more compacted BCD data elements and one more keys to uncompact the BCD data elements to the input/output interface. In one aspect, providing the search result to the input/output interface includes: obtaining one or more compacted BCD data elements from the compacted BCD dataset corresponding to the identified location pointers; uncompacting the one or more compacted BCD data elements into one or more BCD data elements using the translation matrix; and either (1) providing the one or more BCD data elements to the input/output interface, or (2) converting the one or more BCD data elements into one or more data elements, and providing the one or more data elements to the input/output interface. In one aspect, the steps further include determining a relevance of the one or more compacted BCD data elements, the one or more BCD data elements or the one or more data elements. In one aspect, the one or more data elements include a text string, an e-mail, a web page, a document, an audio/visual recording, a video recording, an audio recording, or anything that anything that is machine-readable and machine storable. In one aspect, the search query is received from an artificial intelligence agent or a device communicably coupled to the input/output interface; the search result is sent to the artificial intelligence agent or the device; and the artificial intelligence agent or the device is locally or remotely located with respect to the one or more processors. In one aspect, the steps further include: whenever a revised search query is received by the input/output interface, repeating the compacting, performing, and providing steps for the revised search query; whenever a request for one or more compacted BCD data elements is received by the input/output interface, (1) obtaining the one or more compacted BCD data elements from the compacted BCD dataset corresponding to the identified location pointers, and (2) providing the one or more compacted BCD data elements and one more keys to uncompact the BCD data elements to the input/output interface; and whenever a request for the one or more data elements is received by the input/output interface, (1) obtaining the one or more compacted BCD data elements from the compacted BCD dataset corresponding to the identified location pointers, (2) uncompacting the one or more compacted BCD data elements into the one or more BCD data elements using the translation matrix, and (3)(a) providing the one or more BCD data elements to the input/output interface, or (b) converting the one or more BCD data elements into the one or more data elements, and providing the one or more data elements to the input/output interface. The artificial intelligence agent can be any machine learning software or hardware, existing now or in the future.

In one aspect, the one or more processors include an artificial intelligence search engine. The artificial intelligence search engine can be any machine learning software or hardware, existing now or in the future. In one aspect, the artificial intelligence search engine learns from the search query and the search result. In one aspect, the steps further include refining, limiting or redefining the search query, and repeating the compacting and performing steps for the refined, limited or redefined search query. In one aspect, the steps further include: repeating the refining, limiting or redefining the search query step and the compacting and performing steps until one or more new search results are negative; and including an output decision based on any of the one or more new search results that are positive in the search result. In one aspect, the steps further include: whenever the search result is positive, (1) determining a relevance of the search result to any previous search results, and (2) including an output decision based on the relevance of the search result to any previous search results in the search result; and whenever the search result is negative, (1) refining, limiting or redefining the search query, and (2) repeating the compacting and performing steps for the refined, limited or redefined search query.

In one aspect, the search query includes one or more Boolean operators, or the search term includes a string of alphanumeric characters or symbols, a word, a phrase, an image or a sound. In one aspect, the steps further include interpreting the search query using a natural language model. In one aspect, the location pointer identifies a location of a compacted BCD data element within the compacted BCD dataset or a location of the compacted BCD search term within a compacted BCD data element. In one aspect, the BCD search index further includes one or more adjacent compacted BCD search terms located around the compacted BCD search term within a compacted BCD data element. In one aspect, the steps further include: determining whether the compacted BCD dataset is missing information based on the search result; and providing a message regarding the missing information to the input/output interface. In another aspect, the steps further include: determining whether the compacted BCD dataset is missing information based on the search result; searching one or more data sources for the missing information; obtaining the missing information from the one or more data sources; and adding the missing information to the compacted BCD dataset. In one aspect, adding the missing information to the compacted BCD dataset includes: converting the missing information into BCD information; compacting the BCD information into a compacted BCD information using the translation matrix; adding the compacted BCD information to the compacted BCD dataset; locating a set of compacted BCD search terms withing the compacted BCD information; and adding the set compacted BCD search terms and their corresponding location pointers to the BCD search index. In one aspect, the compacted BCD dataset includes two or more compacted BCD datasets. In one aspect, a set of data elements used to create or update the compacted BCD dataset is not saved or stored. In one aspect, the compacted BCD dataset is searchable in any language. In one aspect, the compacted BCD dataset has been compacted (“folded”) two or more times, the search query is compacted the same number of times as the compacted BCD dataset, and the search result is uncompacted the same number of times as the compacted BCD dataset. In one aspect, the steps further include creating the compacted BCD dataset by: receiving a dataset or a data stream; converting the dataset or the data stream into a BCD dataset; and compacting the BCD dataset into the compacted BCD dataset using the translation matrix. In one aspect, the steps further include updating the compacted BCD dataset with new BCD compacted data. In one aspect, the steps further include creating the new compacted BCD data by: receiving a new dataset or new data stream; converting the new dataset or the new data stream into a new BCD dataset; compacting the new BCD dataset into the new compacted BCD data using the translation matrix; adding the new compacted BCD data to the compacted BCD dataset; locating a set of compacted BCD search terms withing the compacted BCD data; and adding the set compacted BCD search terms and their corresponding location pointers to the BCD search index.

Some non-limiting examples of searches processed by various embodiments of the present disclosure will now be described. The clarification of the searched for material will be the throttle of the speed for the requesting AI search engine. It will be given all relative paths, based on the normalized dictionary, for the requested information. A simple example is a search that wants all information about “ZDAB”. If it exists in the knowledge base, then the output will be all references for this, but if it is not a known entity, then the system will try to determine what the AI was seeking by asking it to look at the possible forks in the data where the request term is not available but was used in fork one document entitled “XXZBC reply MVZDAB” or in the fork of a conversation which used “BAC ZDABYY”, and was used four times during that conversation, or the fork that had a picture that only showed the letters “DAB” Or “ZDA” that was taken in India in 2024 by a tourist.

Note that every occurrence of the search term that was contained in all the data that was “learned” by the BCD system is stored in the BCD search index. The data may be character/image/number/voice or any other media format feed to it while the compacted BCD dataset is built, so the need for speed has driven to the BCD search index or normalized data dictionary, which can be character and number based (such as three alphanumeric characters or bigger). The dictionary points at the correct key in the compacted BCD dataset and contains a complete list of all the locations that data was mined from in the compacted BCD dataset. The dictionary may also contains relative information about the key, such as location in the document or image and other key info before and after it.

A simple example is the one word request “RED”. The first handshake will be YES if it exists and if it has multiple definitions on its usage, which branch is of interest, red as a color, red as a reference to politics/US verses /USSR, or red as an emotion. Based on the return request the output could contain such things as red houses, red trucks. red hair, seeing red, red-hot chili, red futura (future network), red beans and rice, red river valley, red hot food, etc. This would then require a third response from the requesting AI engine to narrow down the amount of data that will be sent back. After as many rounds as necessary to pin down the items of interest, then the system would bubble a response of all the data relevant to the refined request. This bubble would be delivered to the requesting engine with the key it would take to unravel the compressed data back into its original form for the receiving engine then to act upon.

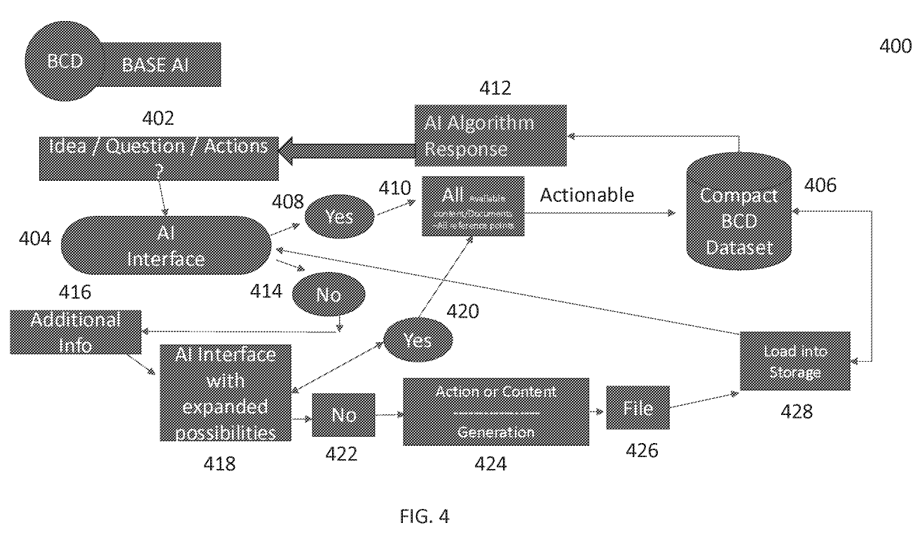

Now referring the FIG. 4, a flow chart of a search process 400 in accordance with one embodiment of the present disclosure is shown. An idea, question or action is presented in block 402 and is provided to an AI interface 404. If the AI interface 404 has sufficient information to search the compacted BCD dataset 406 as indicated by YES 408, all available content/documents and reference points are obtained from the BCD dataset 406 in block 410 and the AI algorithm response is provided in response to the idea, question or action 402 in block 412. If, however, the AI interface does not have sufficient information to search the compacted BCD dataset 406 as indicated by NO 414, additional information 416 is requested from an AI interface with expanded possibilities 418. If the AI interface with expanded capabilities 418 obtains the additional information as indicated by YES 420, the information is passed to block 410. If, however, the additional information is not obtained as indicated by NO 422, action or content is generated in block 424, placed in file 426, loaded into storage 428 and provided to the AI interface 404 and the compacted BCD dataset 406.

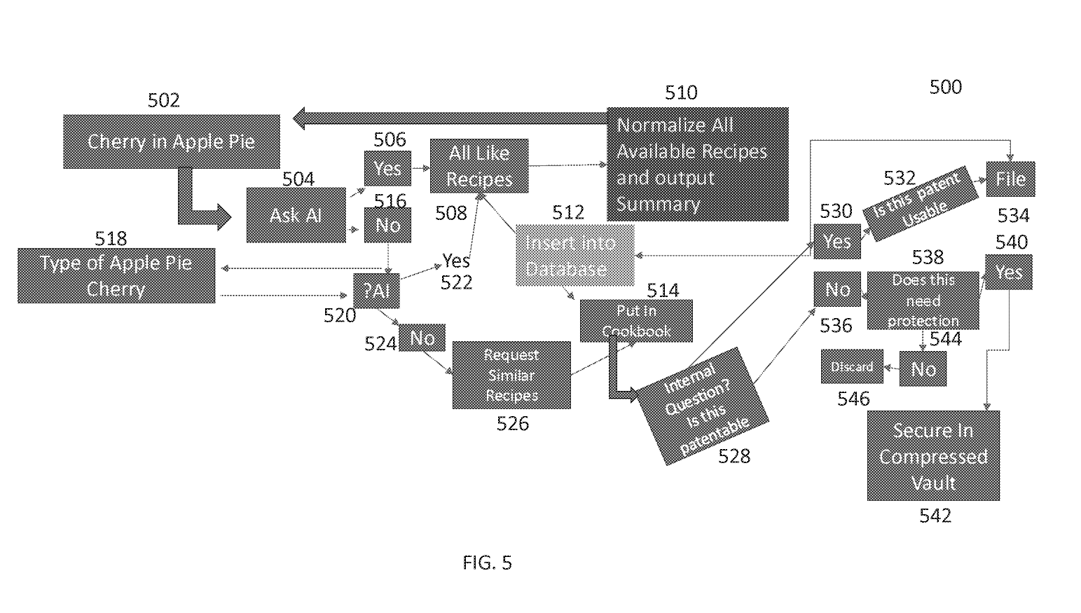

Referring now to FIG. 5, a flow chart 500 of an exemplary search 500 in accordance with one embodiment of the present disclosure is shown. A search query “Is cherry in apple pie” is provided in block 502 and is sent to ask an AI agent 504. If the answer is YES 506, all like recipes are obtained in block 508 and all available recipes are normalized and a summary is outputted in block 510 back to the requestor 502. All the like recipes 508 are also inserted into a database 512 and put into a cookbook 514. If the answer is NO 516, an AI agent 520 searches for types of apple pie and cherry 518. If the answer is YES 522, all like recipes are obtained in block 508. If the answer is NO 524, similar recipes are requested in block 526 and they are put into the cookbook 514. Are the recipes or cookbook patentable in block 528. If YES 530, is the patent usable in block 532. If so, file a patent in block 534 and insert it into the database 512. If NO 536, does this need protection in block 538. If YES 540, secure the data in a compressed vault 542. If NO 544, then discard the data in block 546.

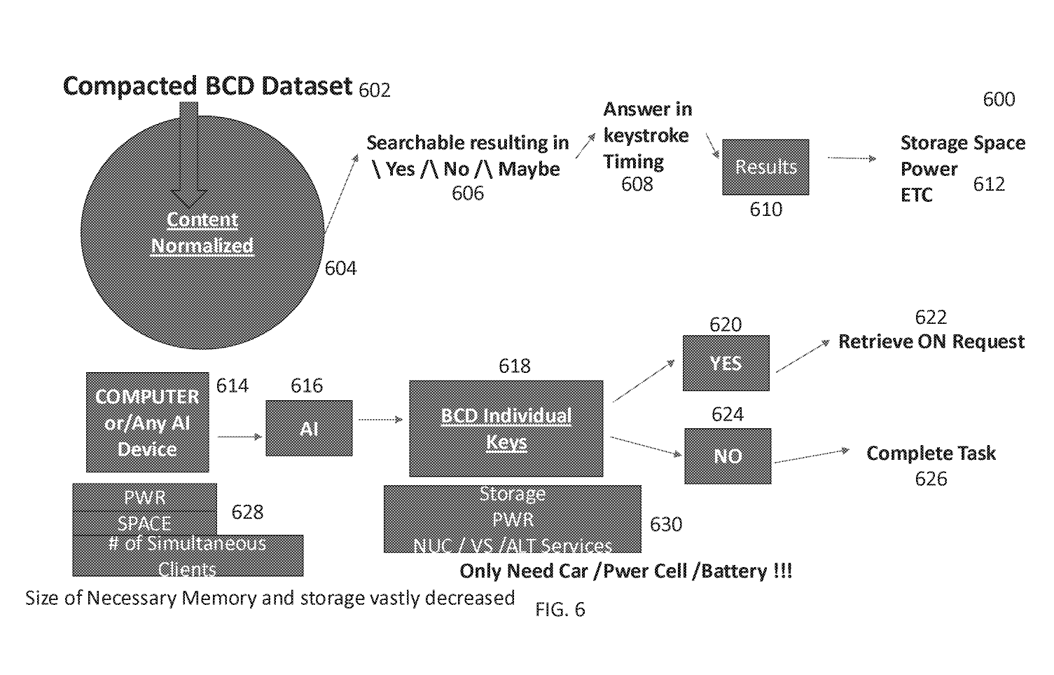

Now referring to FIG. 6, a flow chart 600 of an exemplary system 600 in accordance with one embodiment of the present invention is shown. Content from a compacted BCD dataset 602 is normalized and provided in a BCD search index 604, which is searchable to provide YES, NO and MAYBE results 606. The answer can be provided in keystroke timing 608 to provide results 610, which reduces storage and power requirements 612. A computer or any AI device 614 interacts with an AI agent 616 to search BCD individual keys 618 to determine with the search query exists within the compacted BCD dataset. If YES 620, a request to retrieve the supporting documents 622 is executed. If NO 624, the task is complete 626. Power and storage requirements 628 are reduced in the computer or AI device 614 and large numbers of simultaneous clients can be serviced. Power and storage requirements 630 of the BCD search index and compacted BCD dataset are also reduced.

It will be understood that particular embodiments described herein are shown by way of illustration and not as limitations of the invention. The principal features of this invention can be employed in various embodiments without departing from the scope of the invention. Those skilled in the art will recognize or be able to ascertain using no more than routine experimentation, numerous equivalents to the specific procedures described herein. Such equivalents are considered to be within the scope of this invention and are covered by the claims.

All publications and patent applications mentioned in the specification are indicative of the level of skill of those skilled in the art to which this invention pertains. All publications and patent applications are herein incorporated by reference to the same extent as if each individual publication or patent application was specifically and individually indicated to be incorporated by reference.

The use of the word “a” or “an” when used in conjunction with the term “comprising” in the claims and/or the specification may mean “one,” but it is also consistent with the meaning of “one or more,” “at least one,” and “one or more than one.” The use of the term “or” in the claims is used to mean “and/or” unless explicitly indicated to refer to alternatives only or the alternatives are mutually exclusive, although the disclosure supports a definition that refers to only alternatives and “and/or.” Throughout this application, the term “about” is used to indicate that a value includes the inherent variation of error for the device, the method being employed to determine the value, or the variation that exists among the study subjects.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited features, elements, components, groups, integers, and/or steps, but do not exclude the presence of other unstated features, elements, components, groups, integers and/or steps. In embodiments of any of the compositions and methods provided herein, “comprising” may be replaced with “consisting essentially of” or “consisting of”. As used herein, the term “consisting” is used to indicate the presence of the recited integer (e.g., a feature, an element, a characteristic, a property, a method/process step or a limitation) or group of integers (e.g., feature(s), element(s), characteristic(s), property(ies), method/process steps or limitation(s)) only. As used herein, the phrase “consisting essentially of” requires the specified features, elements, components, groups, integers, and/or steps, but do not exclude the presence of other unstated features, elements, components, groups, integers and/or steps as well as those that do not materially affect the basic and novel characteristic(s) and/or function of the claimed invention.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AB, BBC, AAABCCCC, CBBAAA, CABABB, and so forth. The skilled artisan will understand that typically there is no limit on the number of items or terms in any combination, unless otherwise apparent from the context.

As used herein, words of approximation such as, without limitation, “about”, “substantial” or “substantially” refers to a condition that when so modified is understood to not necessarily be absolute or perfect but would be considered close enough to those of ordinary skill in the art to warrant designating the condition as being present. The extent to which the description may vary will depend on how great a change can be instituted and still have one of ordinary skill in the art recognize the modified feature as still having the required characteristics and capabilities of the unmodified feature. In general, but subject to the preceding discussion, a numerical value herein that is modified by a word of approximation such as “about” may vary from the stated value by at least ±1, 2, 3, 4, 5, 6, 7, 10, 12 or 15%.

All of the compositions and/or methods disclosed and claimed herein can be made and executed without undue experimentation in light of the present disclosure. While the compositions and methods of this invention have been described in terms of preferred embodiments, it will be apparent to those of skill in the art that variations may be applied to the compositions and/or methods and in the steps or in the sequence of steps of the method described herein without departing from the concept, spirit and scope of the invention. All such similar substitutes and modifications apparent to those skilled in the art are deemed to be within the spirit, scope and concept of the invention as defined by the appended claims.

To aid the Patent Office, and any readers of any patent issued on this application in interpreting the claims appended hereto, applicants wish to note that they do not intend any of the appended claims to invoke paragraph 6 of 35 U.S.C. § 112, U.S.C. § 112 paragraph (f), or equivalent, as it exists on the date of filing hereof unless the words “means for” or “step for” are explicitly used in the particular claim.

For each of the claims, each dependent claim can depend both from the independent claim and from each of the prior dependent claims for each and every claim so long as the prior claim provides a proper antecedent basis for a claim term or element.

What is claimed is:

1. A method for searching a compacted binary coded decimal (BCD) dataset comprising:
providing the compacted BCD dataset, a translation matrix and a BCD search index, wherein any portion of the compacted BCD dataset is translatable to a portion of an original dataset using the translation matrix without any losses, and the BCD search index comprises a set of compacted BCD search terms and a location pointer to the compacted BCD dataset for each occurrence of the compacted BCD search terms;
receiving, by one or more processors, a search query from an input/output interface, wherein the search query comprises one or more search terms;
compacting, by the one or more processors, each search term into a compacted BCD search term using the translation matrix;
performing, by the one or more processors, a search of the BCD search index for each compacted BCD search term to identify any location pointers corresponding to the compacted BCD search term; and
providing, by the one or more processors, a search result to the input/output interface.

2. The method of claim 1, wherein the receiving, compacting, performing and providing steps are executed in real time.

3. The method of claim 1, wherein the search result comprises a response indicating whether any location pointers were identified for each BCD search term.

4. The method of claim 3, wherein the response comprises an affirmative response, a negative response or an uncertain response.

5. The method of claim 1, wherein providing the search result to the input/output interface comprises:
obtaining, by the one or more processors, one or more compacted BCD data elements from the compacted BCD dataset corresponding to the identified location pointers; and
providing, by the one or more processors, the one or more compacted BCD data elements and one more keys to uncompact the BCD data elements to the input/output interface.

6. The method of claim 1, wherein providing the search result to the input/output interface comprises:
obtaining, by the one or more processors, one or more compacted BCD data elements from the compacted BCD dataset corresponding to the identified location pointers;
uncompacting, by the one or more processors, the one or more compacted BCD data elements into one or more BCD data elements using the translation matrix; and
either (1) providing, by the one or more processors, the one or more BCD data elements to the input/output interface, or (2) converting, by the one or more processors, the one or more BCD data elements into one or more data elements, and providing, by the one or more processors, the one or more data elements to the input/output interface.

7. The method of claim 6, further comprising determining, by the one or more processors, a relevance of the one or more compacted BCD data elements, the one or more BCD data elements or the one or more data elements.

8. The method of claim 6, wherein the one or more data elements comprise a text string, an e-mail, a web page, a document, an audio/visual recording, a video recording, an audio recording.

9. The method of claim 1, wherein:
the search query is received from an artificial intelligence agent or a device communicably coupled to the input/output interface;
the search result is sent to the artificial intelligence agent or the device; and
the artificial intelligence agent or the device is locally or remotely located with respect to the one or more processors.

10. The method of claim 9, further comprising translating, by the one or more processors, the artificial intelligence agent or the device, the search query or the search result into a different language.

11. The method of claim 9, further comprising:
either (1) providing, by the artificial intelligence agent or the device, the search result to a user, (2) refining, limiting or redefining, by the artificial intelligence agent or the device, the search query and sending a revised search query to the input/output interface, or (3) sending, by the artificial intelligence agent or the device, a request for one or more compacted BCD data elements or one or more data elements from the compacted BCD dataset corresponding to the identified location pointers to the input/output interface;
whenever the revised search query is received by the input/output interface, repeating the compacting, performing, and providing steps, by the one or more processors, for the revised search query;
whenever the request for the one or more compacted BCD data elements is received by the input/output interface, (1) obtaining, by the one or more processors, the one or more compacted BCD data elements from the compacted BCD dataset corresponding to the identified location pointers, and (2) providing, by the one or more processors, the one or more compacted BCD data elements and one more keys to uncompact the BCD data elements to the input/output interface; and
whenever the request for the one or more data elements is received by the input/output interface, (1) obtaining, by the one or more processors, the one or more compacted BCD data elements from the compacted BCD dataset corresponding to the identified location pointers, (2) uncompacting, by the one or more processors, the one or more compacted BCD data elements into the one or more BCD data elements using the translation matrix, and (3)(a) providing, by the one or more processors, the one or more BCD data elements to the input/output interface, or (b) converting, by the one or more processors, the one or more BCD data elements into the one or more data elements, and providing, by the one or more processors, the one or more data elements to the input/output interface.

12. The method of claim 1, wherein the one or more processors comprise an artificial intelligence search engine.

13. The method of claim 12, wherein the artificial intelligence search engine learns from the search query and the search result.

14. The method of claim 12, further comprising refining, limiting or redefining, by the artificial intelligence search engine, the search query, and repeating the compacting and performing steps, by the artificial intelligence search engine, for the refined, limited or redefined search query.

15. The method of claim 14, further comprising:
repeating the refining, limiting or redefining the search query step and the compacting and performing steps until one or more new search results are negative; and
including, by the artificial intelligence search engine, an output decision based on any of the one or more new search results that are positive in the search result.

16. The method of claim 12, further comprising:
whenever the search result is positive, (1) determining, by the artificial intelligence search engine, a relevance of the search result to any previous search results, and (2) including, by the artificial intelligence search engine, an output decision based on the relevance of the search result to any previous search results in the search result; and
whenever the search result is negative, (1) refining, limiting or redefining, by the artificial intelligence search engine, the search query, and (2) repeating the compacting and performing steps, by the artificial intelligence search engine, for the refined, limited or redefined search query.

17. The method of claim 1, wherein:
the search query includes one or more Boolean operators; or
the search term comprises a string of alphanumeric characters or symbols, a word, a phrase, an image or a sound.

18. The method of claim 1, further comprising interpreting, by the one or more processors, the search query using a natural language model.

19. The method of claim 1, wherein the location pointer identifies a location of a compacted BCD data element within the compacted BCD dataset or a location of the compacted BCD search term within a compacted BCD data element.

20. The method of claim 1, wherein the BCD search index further comprises one or more adjacent compacted BCD search terms located around the compacted BCD search term within a compacted BCD data element.

21. The method of claim 1, further comprising:
determining, by the one or more processors, whether the compacted BCD dataset is missing information based on the search result; and
providing, by the one or more processors, a message regarding the missing information to the input/output interface.

22. The method of claim 1, further comprising:
determining, by the one or more processors, whether the compacted BCD dataset is missing information based on the search result;
searching, by the one or more processors, one or more data sources for the missing information;
obtaining, by the one or more processors, the missing information from the one or more data sources; and
adding, by the one or more processors, the missing information to the compacted BCD dataset.

23. The method of claim 22, wherein adding the missing information to the compacted BCD dataset comprises:
converting, by the one or more processors, the missing information into BCD information;
compacting, by the one or more processors, the BCD information into a compacted BCD information using the translation matrix;
adding, by the one or more processors, the compacted BCD information to the compacted BCD dataset;
locating, by the one or more processors, a set of compacted BCD search terms withing the compacted BCD information; and
adding, by the one or more processors, the set compacted BCD search terms and their corresponding location pointers to the BCD search index.

24. The method of claim 1, wherein the compacted BCD dataset comprises two or more compacted BCD datasets.

25. The method of claim 1, wherein a set of data elements used to create or update the compacted BCD dataset is not saved or stored.

26. The method of claim 1, wherein the compacted BCD dataset is searchable in any language.

27. The method of claim 1, wherein:
the compacted BCD dataset has been compacted (“folded”) two or more times;
the search query is compacted the same number of times as the compacted BCD dataset; and
the search result is uncompacted the same number of times as the compacted BCD dataset.

28. The method of claim 1, further comprising creating the compacted BCD dataset by:
receiving, by the one or more processors, a dataset or a data stream;
converting, by the one or more processors, the dataset or the data stream into a BCD dataset; and
compacting, by the one or more processors, the BCD dataset into the compacted BCD dataset using the translation matrix.

29. The method of claim 1, further comprising updating, by the one or more processors, the compacted BCD dataset with new BCD compacted data.

30. The method of claim 29, further comprising creating the new compacted BCD data by:
receiving, by the one or more processors, a new dataset or new data stream;
converting, by the one or more processors, the new dataset or the new data stream into a new BCD dataset;
compacting, by the one or more processors, the new BCD dataset into the new compacted BCD data using the translation matrix;
adding, by the one or more processors, the new compacted BCD data to the compacted BCD dataset;
locating, by the one or more processors, a set of compacted BCD search terms withing the compacted BCD data; and
adding, by the one or more processors, the set compacted BCD search terms and their corresponding location pointers to the BCD search index.

31. A non-transitory computer readable medium having stored thereon a set of instructions for causing one or more processors to search a compacted binary coded decimal (BCD) dataset by performing the steps of:
the one or more processors are communicably coupled to the compacted BCD dataset, a translation matrix and a BCD search index, wherein any portion of the compacted BCD dataset is translatable to a portion of an original dataset using the translation matrix without any losses, and the BCD search index comprises a set of compacted BCD search terms and a location pointer to the compacted BCD dataset for each occurrence of the compacted BCD search terms;
receiving a search query from an input/output interface, wherein the search query comprises one or more search terms;
compacting each search term into a compacted BCD search term using the translation matrix;
performing a search of the BCD search index for each compacted BCD search term to identify any location pointers corresponding to the compacted BCD search term; and
providing a search result to the input/output interface.

32. A system for searching a compacted binary coded decimal (BCD) dataset comprising:
an input/output interface;
a translation matrix;
the compacted BCD dataset, wherein any portion of the compacted BCD dataset is translatable to a portion of an original dataset using the translation matrix without any losses;
a BCD search index comprising a set of compacted BCD search terms and a location pointer to the compacted BCD dataset for each occurrence of the compacted BCD search terms; and
one or more processors communicably coupled to the input/output interface, the translation matrix, the compacted BCD dataset and the BCD search index, wherein the one or more processors are configured to receive a search query from the input/output interface wherein the search query comprises one or more search terms, compact each search query into a compacted BCD search query using the translation matrix, perform a search of the BCD search index for each compacted BCD
search term to identify any location pointers corresponding to the compacted BCD search term, and provide a search result to the input/output interface.
